(19) United States
(12) Patent Application Publication
(10) Pub. No.: US 2012/0026161 A1
(43) Pub. Date: Feb. 2, 2012

(54) STEREOSCOPIC DISPLAY

(75) Inventors: Fu-Hao Chen, Kaohsiung City (TW); Chao-Hsu Tsai, Hsinchu City (TW); Kuo-Tung Tiao, Hsinchu County (TW); Jian-Chiun Liou, Kaohsiung County (TW)

(73) Assignee: INDUSTRIAL TECHNOLOGY RESEARCH INSTITUTE, Hsinchu (TW)

(21) Appl. No.: 13/077,987

(22) Filed: Apr. 1, 2011

Related U.S. Application Data
(60) Provisional application No. 61/369,085, filed on Jul. 30, 2010.

(51) Int. Cl. G06T 15/00

(52) U.S. Cl. 345/419

(57) ABSTRACT

A stereoscopic display including a displaying element, a light converging element, and a scanning element is provided. The displaying element is adapted to provide a light. The light converging element is disposed on a transmission path of the light for converging the light to at least one view region. The scanning element is disposed on the transmission path of the light for changing at least one transmission direction of the light with time. The scanning element includes a plurality of scanning units. Each of the scanning units includes a first electrode, a second electrode, and a first material with anisotropic refractive indices. The first material with anisotropic refractive indices is disposed between the first electrode and the second electrode.

### CROSS-REFERENCE TO RELATED APPLICATION

This application claims the priority benefit of U.S. provisional application Ser. No. 61/369,085, filed on Jul. 30, 2010. The entirety of the above-mentioned patent application is hereby incorporated by reference herein and made a part of specification.

### TECHNICAL FIELD

The disclosure relates to a display, and more particularly, to a stereoscopic display.

### BACKGROUND

With development of display technology, displays having better image quality, richer color performance and better performance effect are continuously developed. In recent years, a stereoscopic display technology has extended to home display applications from cinema applications. Since a key technique of the stereoscopic display technology is to ensure a left eye and a right eye of a user to respectively view left-eye images and right-eye images of different viewing angles, according to the conventional stereoscopic display technology, the user generally wears a special pair of glasses to filter the left-eye images and the right-eye images.

However, to wear the special pair of glasses may generally cause a lot of inconveniences, especially for a nearsighted or farsighted user who has to wear a pair of glasses which corrects vision, the extra pair of special glasses may cause discomfort and inconvenience. Therefore, a naked-eye stereoscopic display technology, i.e. autostereoscopic display technology, becomes one of the key focuses in researches and developments.

The autostereoscopic display technology is categorized into spatial multiplexing technology and temporal multiplexing technology. The spatial multiplexing technology compromises the resolution of the frame to generate a plurality of view regions. On the other hand, the temporal multiplexing technology generates a plurality of view regions but does not compromise the resolution of the frame. However, conventional temporal multiplexing technology needs scanning element operating at very high frequency, which encounters more difficulty in mass production and limits the applicability of the autostereoscopic display.

### SUMMARY

A stereoscopic display including a displaying element, a light converging element, and a scanning element is introduced herein. The displaying element is adapted to provide a light. The light converging element is disposed on a transmission path of the light for converging the light to at least one view region. The scanning element is disposed on the transmission path of the light for changing at least one transmission direction of the light with time. The scanning element comprises a plurality of scanning units. Each of the scanning units comprises a first electrode, a second electrode, and a first material with anisotropic refractive indices. The first material with anisotropic refractive indices is disposed between the first electrode and the second electrode. When voltage between the first electrode and the second electrode is changed, the molecules of the first material with anisotropic refractive indices rotate so as to change the transmission direction of the light with time.

Several exemplary embodiments accompanied with figures are described in detail below to further describe the disclosure in details.

### BRIEF DESCRIPTION OF THE DRAWINGS

The accompanying drawings are comprised to provide further understanding, and are incorporated in and constitute a part of this specification. The drawings illustrate exemplary embodiments and, together with the description, serve to explain the principles of the disclosure.

FIG. 1A is a schematic perspective view of a stereoscopic display according to an exemplary embodiment.

FIG. 1B is a schematic cross-sectional view of the stereoscopic display in FIG. 1A.

FIG. 2 is a schematic cross-sectional view of the scanning element in FIG. 1B.

FIGS. 3A and 3B are schematic cross-sectional views of the scanning unit in FIG. 2 respectively in two different states.

FIG. 4 is schematic cross-sectional view of the scanning unit of a stereoscopic display according to another exemplary embodiment.

FIGS. 5A and 5B are schematic cross-sectional views of the scanning unit of a stereoscopic display according to yet another exemplary embodiment.

FIG. 6 is schematic cross-sectional view of the scanning unit of a stereoscopic display according to still another exemplary embodiment.

FIGS. 7A and 7B are schematic cross-sectional views of the scanning unit of a stereoscopic display in two different states according to yet still another exemplary embodiment.

FIG. 8 is a schematic cross-section view of a stereoscopic display according to yet still another exemplary embodiment.

FIG. 9 is a schematic cross-section view of a stereoscopic display according to yet still exemplary embodiment.

FIG. 10 is a schematic cross-section view of a stereoscopic display according to yet still exemplary embodiment.

FIG. 11 is a schematic cross-section view of a stereoscopic display according to yet still exemplary embodiment.

FIG. 12 is a schematic cross-section view of a stereoscopic display according to yet still exemplary embodiment.

FIG. 13A is a schematic cross-section view of a stereoscopic display according to yet still exemplary embodiment.

FIG. 13B is a schematic cross-section view of the lenticular array assembly in FIG. 13A.

FIG. 14 is a schematic cross-section view of a stereoscopic display according to yet still exemplary embodiment.

FIG. 15 is a schematic cross-section view of a stereoscopic display according to yet still exemplary embodiment.

FIG. 16 is a schematic cross-section view of a stereoscopic display according to yet still exemplary embodiment.

FIG. 17 is a schematic cross-sectional view of the stereoscopic display according to yet still exemplary embodiment.

FIG. 18A is a schematic cross-sectional view of the stereoscopic display according to still yet another exemplary embodiment.

FIG. 18B is a schematic cross-sectional view of the scanning element in FIG. 18A.

### DETAILED DESCRIPTION OF DISCLOSED EMBODIMENTS

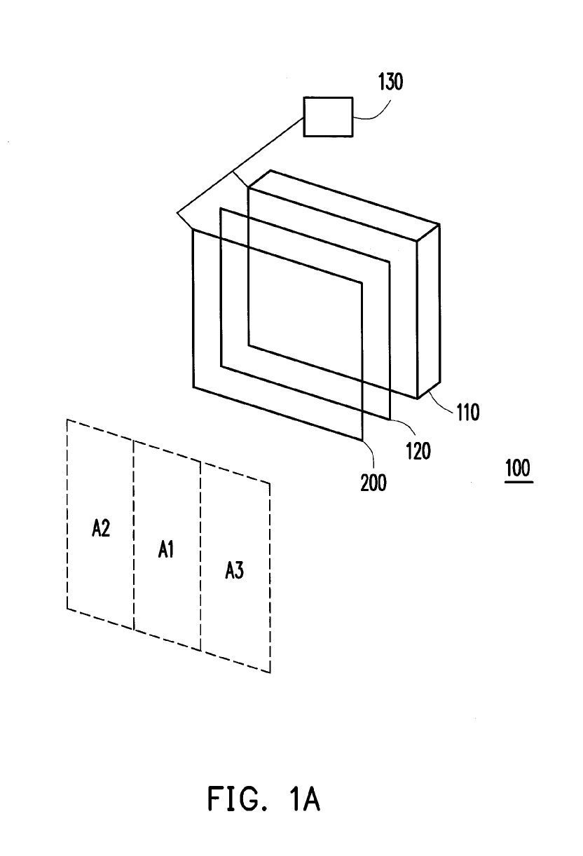

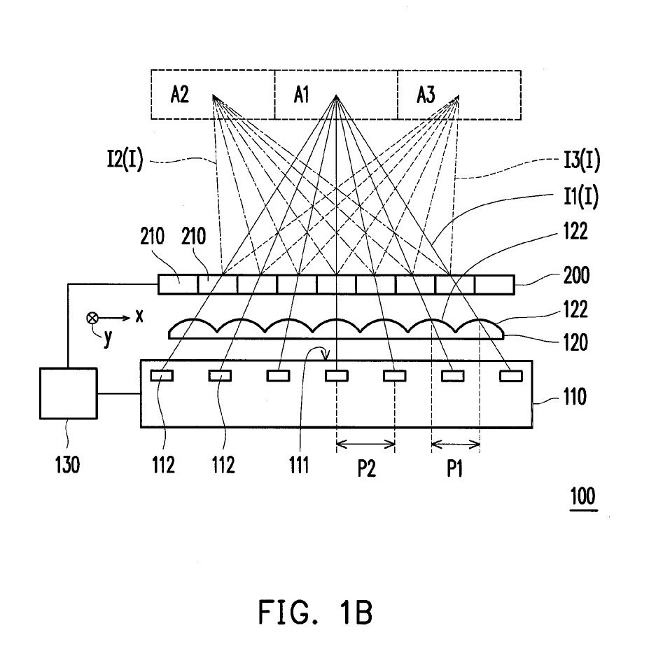

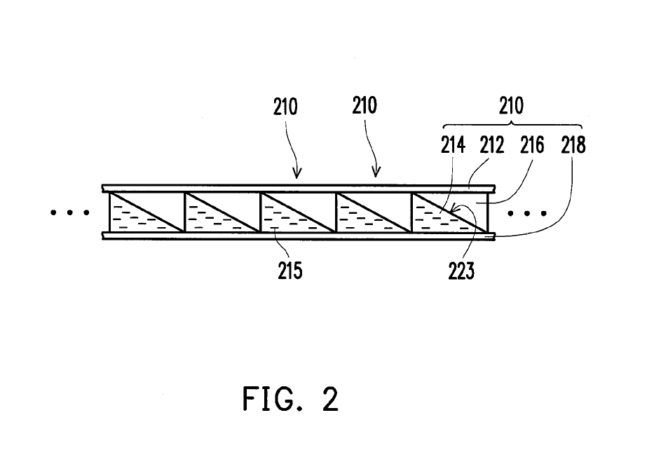

FIG. 1A is a schematic perspective view of a stereoscopic display according to an exemplary embodiment, FIG. 1B is a schematic cross-sectional view of the stereoscopic display in FIG. 1A, and FIG. 2 is a schematic cross-sectional view of the scanning element in FIG. 1B. Referring to FIGS. 1A, 1B, and 2, the stereoscopic display 100 in this embodiment comprises a displaying element 110, a light converging element 120, and a scanning element 200. In this embodiment, the stereoscopic display is, for example, an autostereoscopic display. The displaying element 110 is adapted to provide a light I. In this embodiment, the displaying element 110 is a display, for example, a liquid crystal display (LCD). However, in other embodiments, the displaying element 110 may be a self-luminous display, for example, an organic light emitting diode (OLED) array display, a plasma display panel (PDP), a light emitting diode (LED) array display, a cathode ray tube (CRT), or another display device. Moreover, in this embodiment, the light I is, for example, an image light carrying the information of image frames.

The light converging element 120 is disposed on a transmission path of the light I for converging the light I to at least one view region. For example, the light converging element 120 converges the light I (i.e. the light I1 shown in FIG. 1B) to a view region A1 as shown in FIG. 1B. In this embodiment, the converging element 120 is a lenticular array. Specifically, the lenticular array comprises a plurality of rod-shaped lenticular lenses 122 arranged along a direction, e.g. the x-direction in FIG. 1B. Each of the rod-shaped lenticular lenses 122 extends along a y-direction substantially perpendicular to the x-direction, as shown in FIG. 1B. In this embodiment, each of the rod-shaped lenticular lenses 122 is a plane-convex lens, but the disclosure is not limited thereto. Moreover, in this embodiment, the pitch P1 of the rod-shaped lenticular lenses 122 corresponds to N time(s) the pitch P2 of pixels 112 of the displaying element 110, and N is a natural number. In this embodiment, the pitch P1 corresponds to one time the pitch P2. That is to say, the size of the pitch P1 is about the size of the pitch P2. For example, the pitch P1 is 0.9 times to 1 time the pitch P2. As a result, the light converging element 120 of this embodiment generates a single view image.

The scanning element 200 is disposed on the transmission path of the light I for changing at least one transmission direction of the light I with time. In this embodiment, the light converging element 120 is disposed between the displaying element 110 and the scanning element 200. Since the light converging element 120 converges the light I, the light I after passing through the light converging element 120 has multiple transmission directions. In this embodiment, the scanning element 200 is adapted to change the transmission directions of the light I1 to the transmission directions of the light I2, so that the light I can be transmitted to the view region A2. Moreover, the scanning element 200 is also adapted to change the transmission directions of the light I1 to the transmission directions of the light I3, so that the light can be transmitted to the view region A3. The scanning element 200 transmits the light Ito the view regions A1, A2, and A3 at different time.

Specifically, the scanning element 200 comprises a plurality of scanning units 210. Each of the scanning units 210 comprises a first electrode 212, a second electrode 218, and a first material 214 with anisotropic refractive indices. The first material 214 with anisotropic refractive indices is disposed between the first electrode 212 and the second electrode 218. In this embodiment, the first material 214 with anisotropic refractive is a birefringent material, for example, liquid crystal. Each liquid crystal molecule has an extraordinary index of refraction nₑ and an ordinary index of refraction nₒ. In this embodiment, when the electric field of light is parallel to the optical axis of the liquid crystal molecule, the liquid crystal molecule serves as a material with the extraordinary index of refraction nₑ. On the other hand, when the electric field of light is perpendicular to the optical axis of the liquid crystal molecule, the liquid crystal molecule serves as a material with ordinary index of refraction nₒ. In this embodiment, nₑ>nₒ. However, in other embodiment, the liquid crystal with nₑ<nₒ may also be used.

In this embodiment, each of the scanning units 210 further comprises a transparent material 216 disposed beside the first material 214 with anisotropic refractive indices and between the first electrode 212 and the second electrode 218, and an interface 223 of the first material 214 with anisotropic refractive indices and the transparent material 216 is inclined with respect to a displaying surface 111 of the displaying element 110. In this embodiment, the transparent material 216 is, for example, a solid prism.

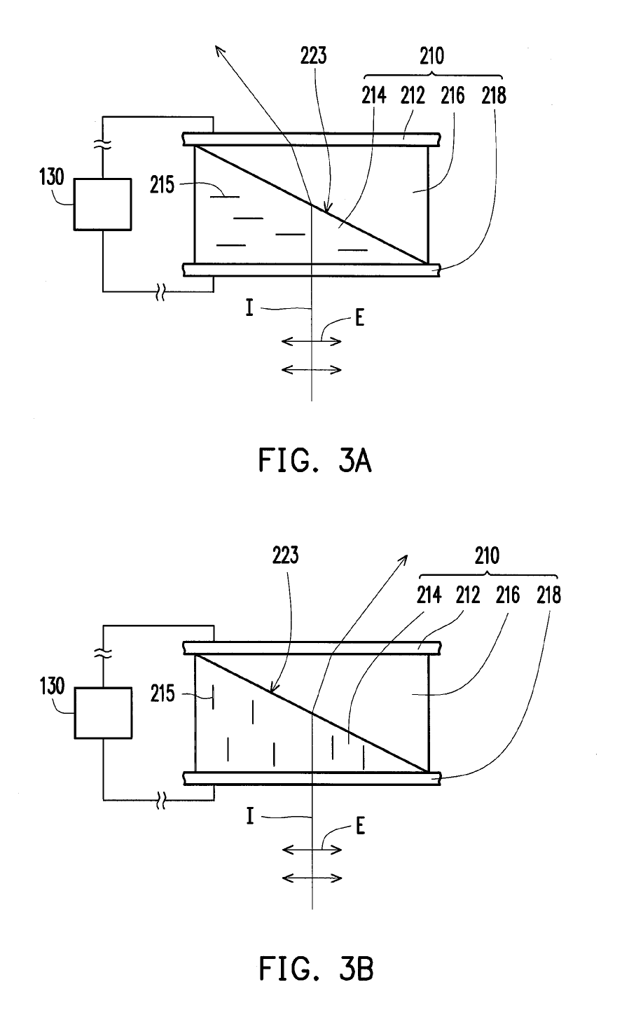

FIGS. 3A and 3B are schematic cross-sectional views of the scanning unit in FIG. 2 respectively in two different states. Referring to FIGS. 1B, 2, 3A, and 3B, when voltage between the first electrode 212 and the second electrode 218 is changed, the molecules 215 of the first material 214 with anisotropic refractive indices rotate so as to change the transmission direction of the light I with time.

Specifically, the light I provided by the displaying element 110 is, for example, a linearly polarized beam. In this embodiment, when the scanning unit 210 is in the state of FIG. 3A, the molecules 215 lie down and is about parallel to the second electrode 218, and the electric field E of the light I is parallel to the optical axes of the molecules 215. At this time, the first material 214 serves as a material with nₑ to transmit the light I. Moreover, the transparent material 216 has an index of refraction nₜ. In this embodiment, nₑ>nₜ>nₒ, but the disclosure is not limited thereto. Since nₑ>nₜ, when the light I passes through the interface 223, the light I is refracted toward the left.

On the other hand, when the scanning unit 210 is in the state of FIG. 3B, the molecules 215 stands up and is about perpendicular to the second electrode 218, and the electric field E of the light I is perpendicular to the optical axes of the molecules 215. At this time, the first material 214 serves as a material with nₒ to transmit the light I. Since nₒ<nₜ, when the light I passes through the interface 223, the light I is refracted toward the right.

The orientations of the molecules 215 are determined by the voltage between the first electrode 212 and the second electrode 218. Therefore, by changing the voltage between the first electrode 212 and the second electrode 218 with time, the transmission directions of the light I are changed with time. As a result, the stereoscopic display transmits the light Ito the view regions A1, A2, and A3 at different time. In this embodiment, the changing period of the transmission directions of the light I is short enough so that a user can observe continuous images. In this way, when a left eye and a right eye of the user are respectively located in the view regions A2 and A1, the user observes a stereoscopic image at a viewing angle. Moreover, when a left eye and a right eye of a user are respectively located in the view regions A1 and A3, the user observes another stereoscopic image at another viewing angle.

As long as the changing period of the transmission directions of the light I is short enough so that the user can observe continuous images, the changing period of the transmission directions is short enough to generate good multi-view images, and thus the operation frequency of the scanning element can be lower. As a result, the stereoscopic display 100 of this embodiment is favorable for mass production, and it has more applicability.

In this embodiment, the stereoscopic display 100 further comprises a control unit 130 for controlling the voltage between the first electrode 212 and the second electrode 218 so as to control rotation of the molecules of the first material with anisotropic refractive indices. Moreover, the control unit 130 controls the displaying element 110 to display a plurality of frames at different time respectively corresponding to transmission orientations of the light I at different time. For example, when the control unit 130 controls the voltage so that the light I is transmitted to the view region A2, the displaying element 110 provides the light I2 containing a first view frame. When the control unit 130 controls the voltage so that the light I is transmitted to the view region A1, the displaying element 110 provides the light I1 containing a second view frame. When the control unit 130 controls the voltage so that the light I is transmitted to the view region A3, the displaying element 110 provides the light I3 containing a third view frame. When the left eye and the right eye of the user are respectively located in the view regions A2 and A1, the brain of the user combines the first view frame and the second view frame to form a first view stereoscopic image. On the other hand, when the left eye and the right eye of another user are respectively located in the view regions A1 and A3, the brain of the user combines the second view frame and the third view frame to form a second view stereoscopic image. The first view stereoscopic image simulates a view seen by the user from an orientation, and the second view stereoscopic image simulates a view seen by the user from another orientation. As a result, a plurality of users can watch the stereoscopic display 100 at the same time, and the users can see different stereoscopic images from different orientation, which is similar to that the objects in the images are in the 3-dimensional space so that the users located at different positions see different portions of the objects from different orientations.

In this embodiment, when the control unit 130 changes the voltage between the first electrode 212 and the second electrode 218 from a first voltage value to a second voltage value, the light I scans from a first orientation (e.g. the orientation in which the light I is transmitted to the view region A2) to a second orientation (e.g. the orientation in which the light I is transmitted to the view region A3). On the other hand, when the control unit 130 changes the voltage between the first electrode 212 and the second electrode 218 from the second voltage value to the first voltage value, the light I scans from the second orientation to the first orientation. In this embodiment, when the light I scans from the first orientation to the second orientation, the light scans through a third orientation (e.g. the orientation in which the light I is transmitted to the view region A1). Moreover, when the light I scans from the second orientation to the first orientation, the light I also scans through a third orientation.

In this embodiment, the first voltage value is substantially zero. For example, the second electrode 218 is grounded. When the control unit 130 does not apply voltage to the first electrode 212, the voltage between the first electrode 212 and the second electrode 218 is substantially zero. At this time, the molecules 215 lie down, and the light I is refracted toward the left. When the control unit 130 applies voltage to the first electrode 212, the voltage between the first electrode 212 and the second electrode 218 is not zero, and the light is refracted toward the right. That is to say, when the control unit 130 turns on the voltage, the molecules 215 rotate from the orientation shown in FIG. 3A to the orientation shown in FIG. 3B, and the light I scans the view regions A2, A1, and A3 in sequence. When the control unit 130 turns off the voltage, the molecules 215 rotates from the orientation shown in FIG. 3B to the orientation shown in FIG. 3A, and the light I scans the view regions A3, A1, and A2 in sequence. As a result, if the frequency of each frame is 60 Hz, the scanning frequency of the canning element 200 may be 30 Hz, and the frequency of the control unit 130 to drive the scanning element 200 may be 30 Hz. That is to say, the operation frequency of the scanning element 200 is effectively reduced. Moreover, in this embodiment, what the control unit 130 does is to turn on the voltage to a single value and turn off the voltage, which is very simple. As a result, the control unit 130 may be effectively simplified, which reduces the cost of the control unit 130.

The disclosure does not limit the number of the view regions to three. In other embodiments, the view regions may be more than three, and the control unit controls the displaying element to display more than three frames respectively when the light scans more than three view regions.

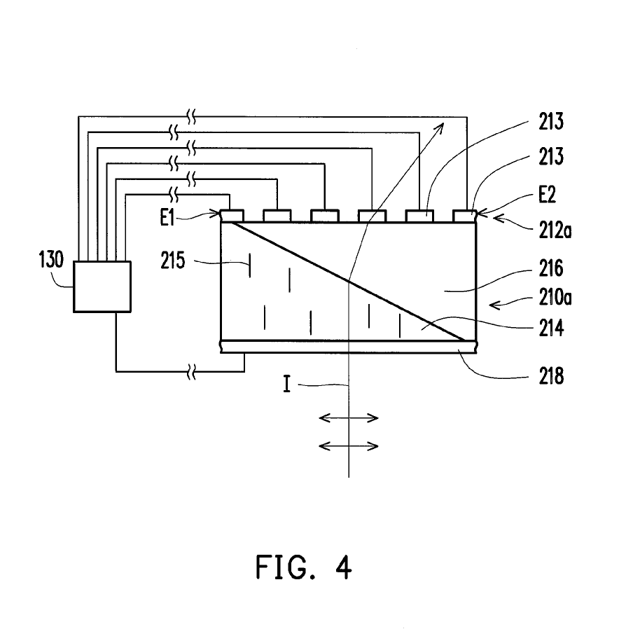

FIG. 4 is schematic cross-sectional view of the scanning unit of a stereoscopic display according to another exemplary embodiment. Referring to FIG. 4, the stereoscopic display of this embodiment is similar to the stereoscopic display 100 shown in FIG. 1B, and the differences therebetween are as follows. In the scanning unit 210a according to this embodiment, a first electrode 212a comprises a plurality of discrete sub-electrodes 213 arranged from a first end E1 of the first electrode 212a to a second end E2 of the first electrode 212a. When the control unit 130 apply voltage to the first electrode 212a, the control unit 130 respectively applies a plurality of voltage values to the discrete sub-electrodes 213, and the voltage values decreases from the first end E1 to the second end E2. Since the thickness of the first material 214 decreases from the first end E1 to the second end E2, the voltage values decreasing from the first end E1 to the second end E2 makes the rotation of the molecules more simultaneous, which makes the refraction of the light I more accurate. In another embodiment, the second electrode 218 may also comprise a plurality of discrete sub-electrodes, and when the control unit 130 apply a plurality of voltage values, respectively to the sub-electrodes, decreasing from the first end E1 to the second end E2. Alternatively, the first electrode may be a continuous electrode while the second electrode comprises a plurality of discrete sub-electrodes.

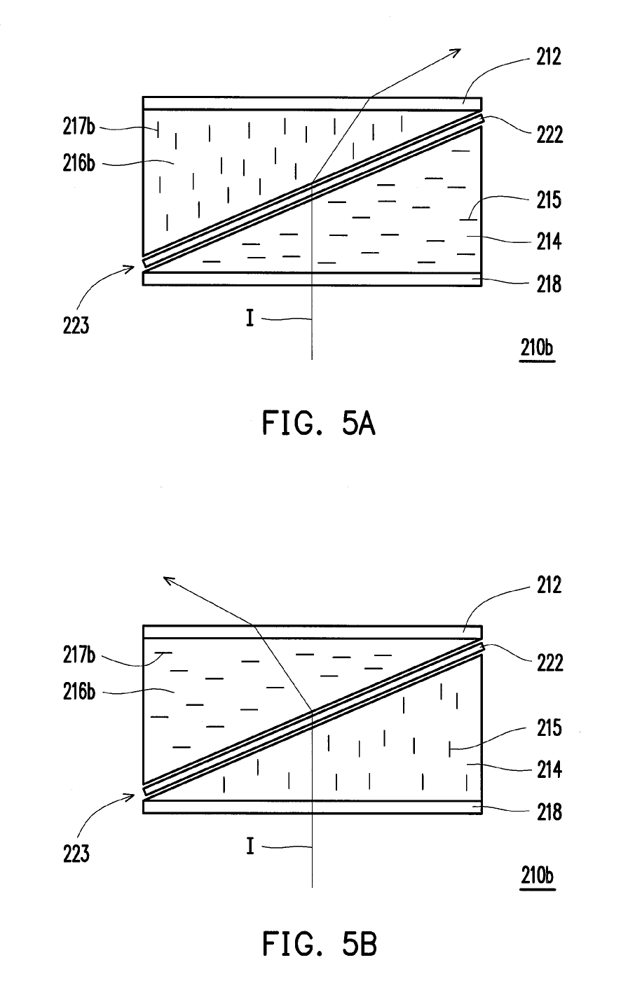

FIGS. 5A and 5B are schematic cross-sectional views of the scanning unit of a stereoscopic display according to yet another exemplary embodiment. Referring to FIGS. 5A and 5B, the stereoscopic display in this embodiment is similar to the stereoscopic display 100 in FIG. 1B, and the differences therebetween are as follows. In this embodiment, each of the scanning unit 210b further comprises a transparent plate 222 disposed at the interface 223, wherein a transparent material 216b is liquid, and the transparent plate 222 separates the first material 214 with anisotropic refractive indices and the transparent material 216b. Moreover, in this embodiment, the transparent material 216b is a second material with anisotropic refractive indices, for example, liquid crystal. In addition, the transparent plate 222 is a third electrode. In the state shown in FIG. 5A, the control unit applies voltage between the first electrode 212 and the third electrode (i.e. the transparent plate 222), and molecules 217b of the transparent material 216b stand up, so that the transparent material 216b serves as a material with the ordinary index of refraction of the molecules 217b to transmit the light I. At this time, the control unit does not apply voltage between the second electrode 218 and the third electrode (i.e. the transparent plate 222), and the molecules 215 of the first material 214 lie down, so that the first material 214 serves as a material with the extraordinary index of refraction of the molecules 215 to transmit the light I. In this embodiment, the extraordinary index of refraction of the molecules 215 is greater than the ordinary index of refraction of the molecules 217b, so that the light I is refracted toward the right.

On the other hand, in the state shown in FIG. 5B, the control unit does not apply voltage between the first electrode 212 and the third electrode (i.e. the transparent plate 222), and molecules 217b of the transparent material 216b lie down, so that the transparent material 216b serves as a material with the extraordinary index of refraction of the molecules 217b to transmit the light I. At this time, the control unit applies voltage between the second electrode 218 and the third electrode (i.e. the transparent plate 222), and the molecules 215 of the first material 214 stand up, so that the first material 214 serves as a material with the ordinary index of refraction of the molecules 215 to transmit the light I. In this embodiment, the ordinary index of refraction of the molecules 215 is less than the extraordinary index of refraction of the molecules 217b, so that the light I is refracted toward the left. When the scanning element 210b changes the state from that shown in FIG. 5A to that shown in FIG. 5B, the light I scans from the right to the left. On the other hand, when the scanning element 210b changes the state from that shown in FIG. 5B to that shown in FIG. 5A, the light I scans from the left to the right.

In another embodiment, the transparent plate 222 may not serve as an electrode, and the control unit does not apply voltage to the transparent plate 222. Moreover, the molecules 215 and molecules 217b are respectively two different types of liquid crystal molecules. The molecules 217b stand up when there is no electric field and lie down when there exists an electric field, while the molecules 215 stand up when there exists an electric field and lie down when there is no electric field. Alternatively, the extraordinary index of refraction of the molecules 217b may be less than the ordinary index of refraction of the molecules 217b, while the extraordinary index of refraction of the molecules 215 may be greater than the ordinary index of refraction of the molecules 215. In yet another embodiment, the transparent material 216b may also be replaced by a material with isotropic index of refraction.

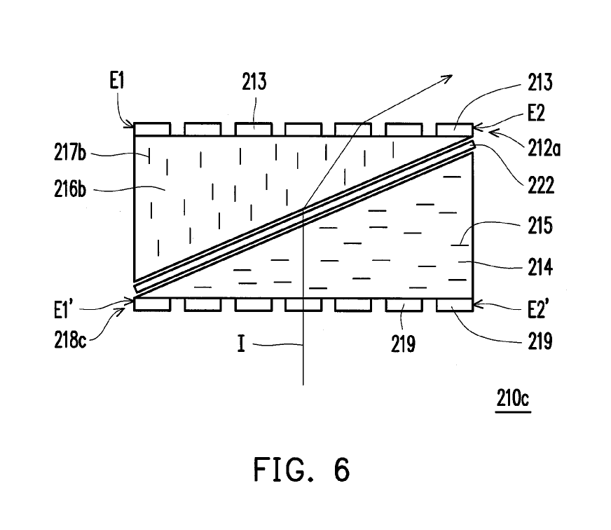

FIG. 6 is schematic cross-sectional view of the scanning unit of a stereoscopic display according to still another exemplary embodiment. Referring to FIG. 6, a scanning unit 210c in this embodiment is similar to the scanning unit 210b in FIGS. 5A and 5B, and the differences therebetween are as follows. In the scanning unit 210c according to this embodiment, the first electrode 212a comprises a plurality of discrete sub-electrodes 213, and the second electrode 218c comprises a plurality of discrete sub-electrodes 219. When the control unit applies a plurality of voltage values respectively to the sub-electrodes 213, the voltage values decrease from the first end E1 to the second end E2. However, when the control unit applies a plurality of voltage values respectively to the sub-electrodes 219, the voltage values increase from the first end E1′ of the second electrode 218c to the second end E2′ of the second electrode 218c. The effect achieved by this embodiment is similar to that described in the embodiment of FIG. 4, so that it is not repeated herein.

In another embodiment, the second electrode may be a continuous electrode while the first electrode comprises a plurality of sub-electrodes. Alternatively, the first electrode may be a continuous electrode while the second electrode comprises a plurality of sub-electrodes.

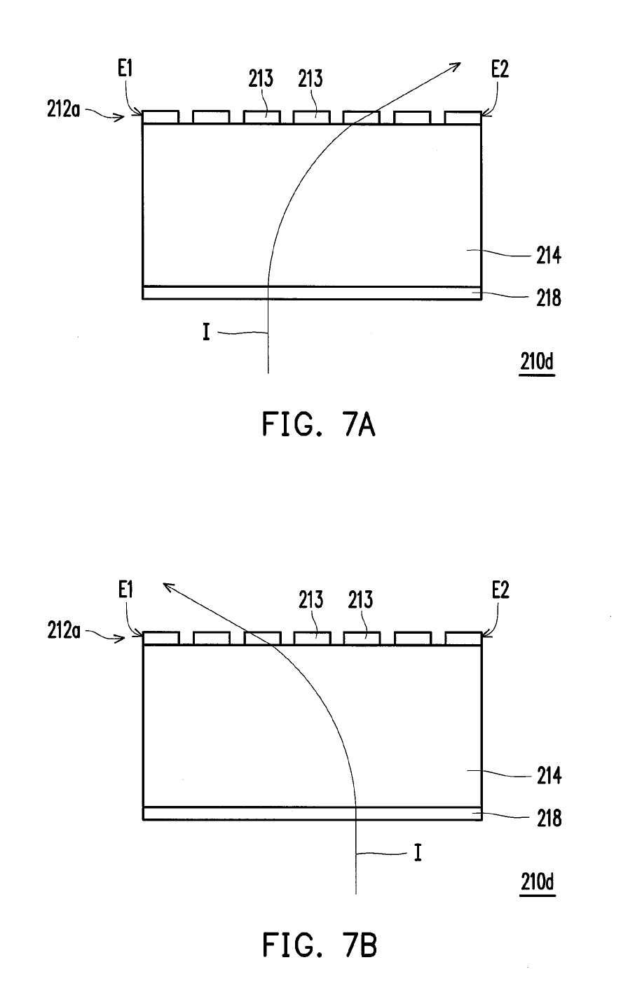

FIGS. 7A and 7B are schematic cross-sectional views of the scanning unit of a stereoscopic display in two different states according to yet still another exemplary embodiment. Referring to FIGS. 7A and 7B, the stereoscopic display in this embodiment is similar to the stereoscopic display 100 in FIG. 1B, and the differences therebetween are as follows. In the scanning unit 210d of this embodiment, there is no transparent material 216 as shown in FIG. 2. Moreover, the first electrode 212a comprises a plurality of discrete sub-electrodes 213. In the state shown in FIG. 7A, the control unit applies a plurality of voltage values decreasing from the first end E1 to the second end E2, and the index of refraction of the first material 214 increases from the first end E1 to the second end E2, so that the light I refracted toward the right. On the other hand, in the state shown in FIG. 7B, the control unit applies a plurality of voltage values increasing from the first end E1 to the second end E2, and the index of refraction of the first material 214 decreases from the first end E1 to the second end E2, so that the light I refracted toward the left.

When the state of the scanning element 210d changes from that shown in FIG. 7A to that shown in FIG. 7B, the light I scans from the right to the left. On the other hand, when the state of the scanning element 210d changes from that shown in FIG. 7B to that shown in FIG. 7A, the light I scans from the left to the right.

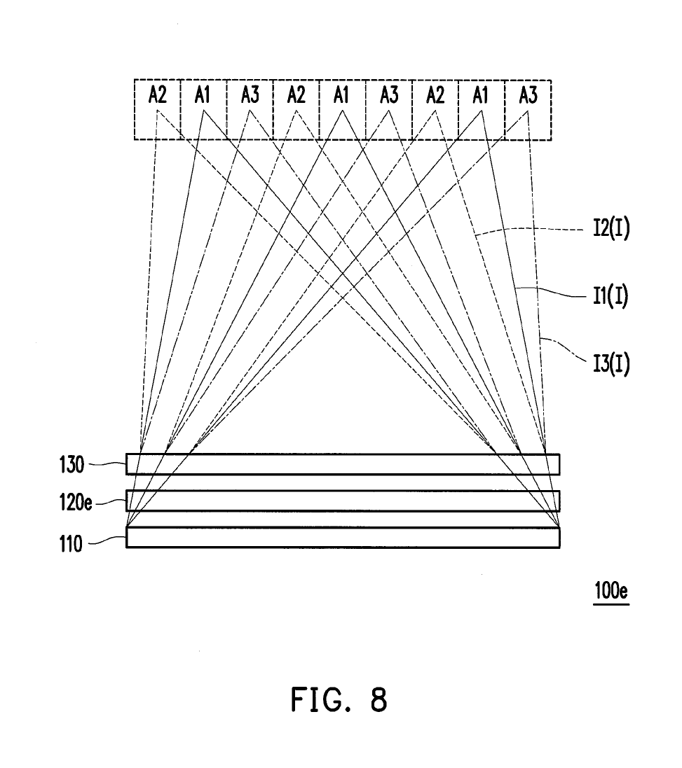

FIG. 8 is a schematic cross-section view of a stereoscopic display according to yet still another exemplary embodiment. Referring to FIG. 8, the stereoscopic display 100e in this embodiment is similar to the stereoscopic display 100 in FIG. 1B, and the difference therebetween is as follows. In the stereoscopic display 100e, the converging element 120e is a lenticular array, and the distance between the converging element 120e and the displaying element 110 and the pitch of the rod-shaped lenticular lenses are appropriate designed so that the spatial frequency of the view regions is increased. As a result, a plurality of view regions A1 repeats from the left to the right, and so do the view regions A2 and A3. That is to say, the stereoscopic display 100 generates a plurality of sets of three views. Specifically, when the scanning units of the scanning element 130 are in the state shown in FIG. 3A, the light I is transmitted to the plurality of view regions A2, and the view regions A2, A1, and A3 repeat again and again in the space from the left to the right. On the other hand, when the scanning units of the scanning element 130 are in the state shown in FIG. 3B, the light I is transmitted to the plurality of view regions A3. When the scanning units are in the state between that shown in FIG. 3A and that shown in FIG. 3B, the light I is transmitted to the plurality of view regions A1. The scanning angle of the scanning element 130 covers the range within which each sub-light of the light I scans from the view region A2 through the view region A1 to the view region A3 in a single set of the view regions A2, A1, and A3, and the converging element 120e splits the light into a plurality of sub-lights respectively transmitted to different sets of the view regions A2, A1, and A3.

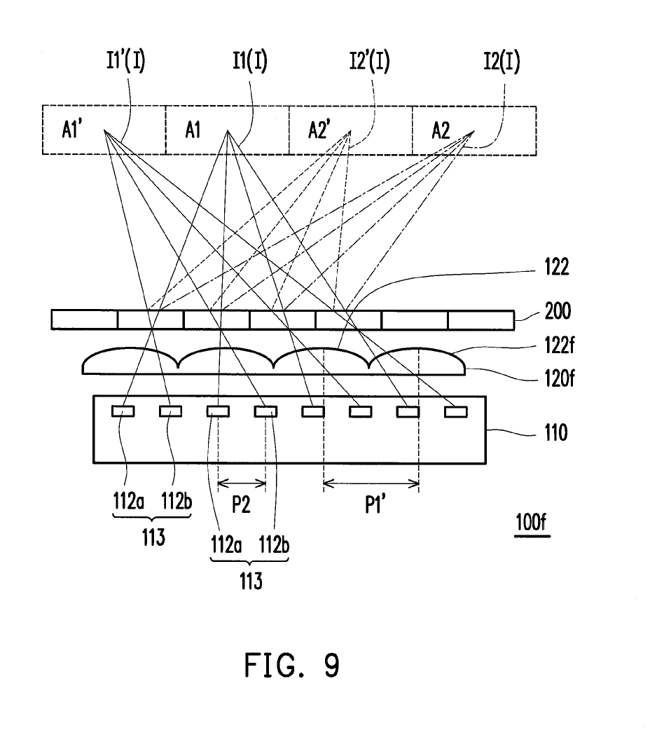

FIG. 9 is a schematic cross-section view of a stereoscopic display according to yet still exemplary embodiment. Referring to FIG. 9, the stereoscopic display 100f in this embodiment is similar to the stereoscopic display 100 in FIG. 1B, and the difference therebetween is as follows. The stereoscopic display 100 uses temporal multiplexing technology, i.e. the light I scanning different view regions A2, A1, and A3 at different time. However, the stereoscopic display 100f uses both the temporal multiplexing technology and the spatial multiplexing technology. Specifically, in this embodiment, the pitch P1′ of the rod-shaped lenticular lenses 122f of a converging element 120f corresponds to 2 times the pitch P2 of pixels 112 of the displaying element 110. That is to say, the size of the pitch P1′ is about two times the size of the pitch P2. For example, the pitch P1′ is 1.8 to 2 times the pitch P2. As a result, the converging element 120f of this embodiment generates two view images. For example, the light I1 from the odd columns of the pixels 112 is transmitted to the view region A1, and the light I1′ from the even columns of the pixels 112 is transmitted to the view region A1′. Moreover, the scanning element 200 makes the light I scan from where the light I1 scans to where the image I2 scans, and the scanning element 200 makes the light I scan from where the light I1′ scans to where the light I2′ scans. As a result, the converging element 120f achieves spatial multiplexing, and the scanning element 200 achieves temporal multiplexing.

Specifically, every two adjacent lines of the pixels 112 (one line is denoted by 112a, and the other line is denoted by 112b) form a pixel set 113, and the control unit 130 (referring to FIG. 1B) is also for driving different lines of the pixels 112 in each of the pixel sets 113 to respectively show images of two different viewing angles. Specifically, all the pixels 112a of the displaying element 110 show an image of a first viewing angle, and meanwhile all the pixels 112b of the displaying element 110 show another image of a second viewing angle, which achieves spatial multiplexing. When the scanning element 200 scans, the pixels 112a show images of different viewing angles at different time, and the pixels 112b also show images of different viewing angles at different time, which achieves temporal multiplexing.

In other embodiments, the pitch of the rod-shaped lenticular lenses of the converging element corresponds to K times the pitch P2 of pixels 112 of the displaying element 110, wherein K is an integer greater than and equal to 3. As a result, the converging element generates K view images. That is to say, the size of the pitch of the rod-shaped lenticular lenses is about K times the size of the pitch P2. For example, the pitch of the rod-shaped lenticular lenses is 0.9K to 1K times the pitch P2, every K adjacent lines of the pixels 112 form a pixel set 113, and the control unit 130 (referring to FIG. 1B) is also for driving different lines of the pixels 112 in each of the pixel sets 113 to respectively show images of K different viewing angles.

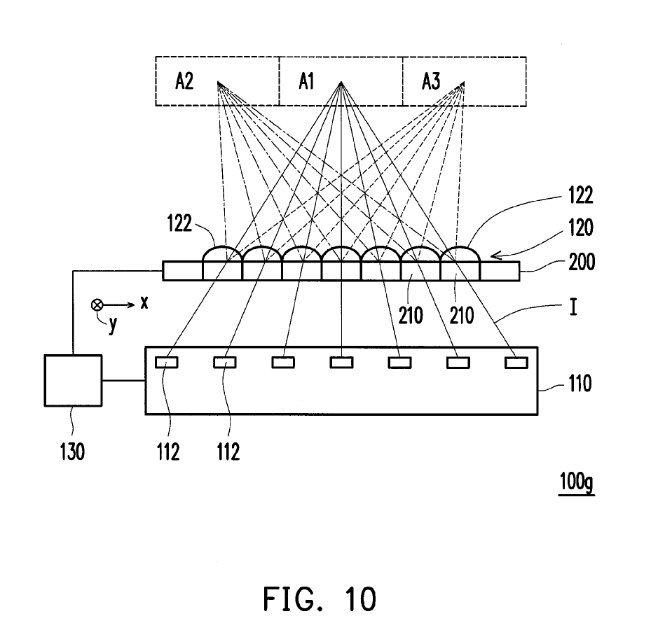

FIG. 10 is a schematic cross-section view of a stereoscopic display according to yet still exemplary embodiment. Referring to FIG. 10, the stereoscopic display 100g in this embodiment is similar to the stereoscopic display 100 in FIG. 1B, and the difference therebetween is as follows. In the stereoscopic display 100g in this embodiment, the scanning element 200 is disposed between the displaying element 110 and the light converging element 120. The scanning element 200 makes the light I scan the converging element 120 first, and the converging element 120 then converges the image I to the view regions A2, A1, and A3 at different time.

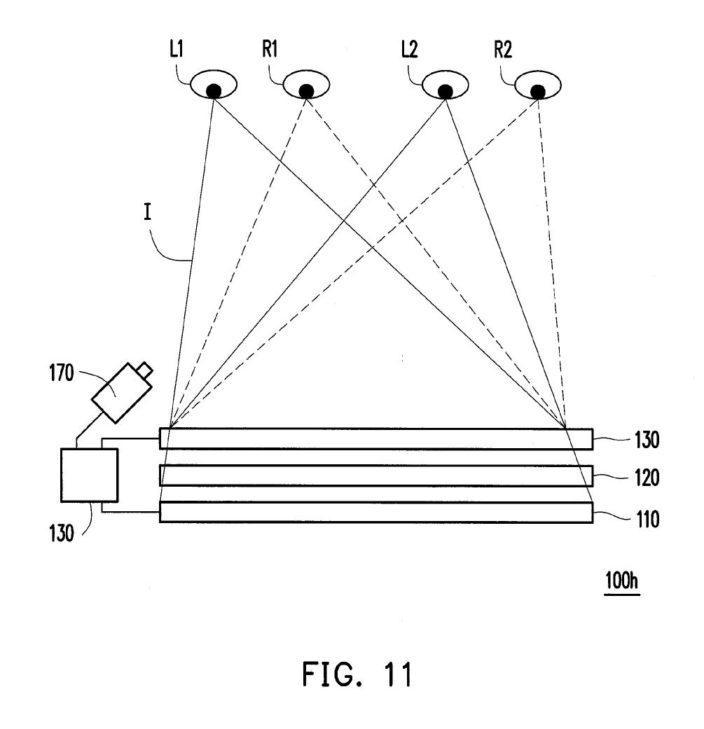

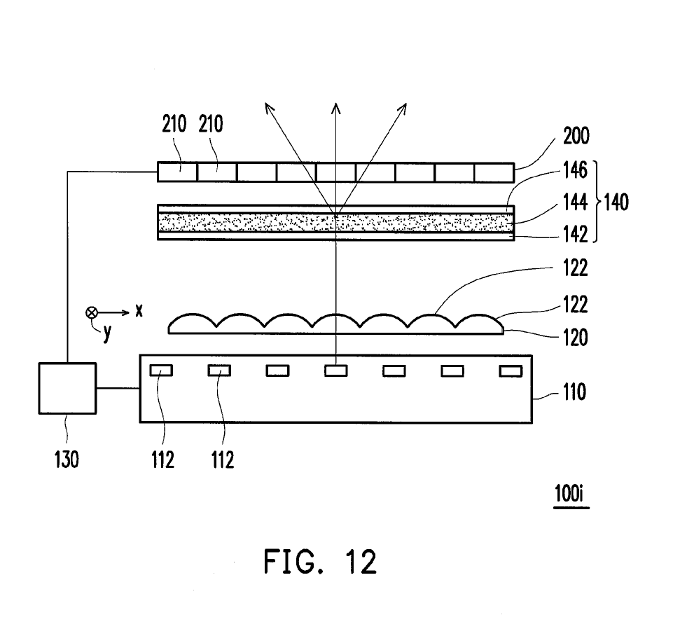

FIG. 11 is a schematic cross-section view of a stereoscopic display according to yet still exemplary embodiment. Referring to FIG. 11, the stereoscopic display 100h in this embodiment is similar to the stereoscopic display 100 in FIG. 1B, and the difference therebetween is as follows. The stereoscopic display 100h in this embodiment further comprises a sensor 170 for detecting positions of eyes of at least one user (FIG. 11 showing two users). The sensor 170 is, for example, a charge coupled device (CCD) camera, or a complementary metal oxide semiconductor (CMOS) camera. The control unit 130 controls the rotation of the molecules of the first material 214 (see FIG. 2) with anisotropic refractive indices so that the light I scans the positions of the eyes of the user. For example, the light I scans the left eye L1 and the right eye R1 of a first user, and scans the left eye L2 and the right eye R2 of a second user. When the light I scans the left eye L1, the right eye R1, the left eye L2, and the right eye R2 in sequence, the control unit 130 controls the displaying element 110 to respectively display corresponding frames to left eye L1, the right eye R1, the left eye L2, and the right eye R2 in sequence. As a result, the operation frequency of the displaying element 110 may be adjusted according to the number of the user(s). When the number of the user(s) is less, the displaying element 110 may operate in lower frequency, which saves the power and lengthen the life span of the displaying element 110. Moreover, in this embodiment, when the positions of the eyes of the user move, the control unit 130 controls the rotation of the molecules so that the light dynamically follows movement of the eyes of the user. Moreover, when the molecules of the first material 214 rotate to the orientation corresponding to the positions of the eyes of the user, the control unit 130 controls the displaying element 110 to display corresponding frames. As a result, the user can see correct stereoscopic frames at different positions.

FIG. 12 is a schematic cross-section view of a stereoscopic display according to yet still exemplary embodiment. Referring to FIG. 12, the stereoscopic display 100i in this embodiment is similar to the stereoscopic display 100 in FIG. 1B, and the difference therebetween is as follows. In this embodiment, the stereoscopic display 100i further comprises a switchable scattering panel 140 disposed on the transmission path of the light I between the light converging element 120 and the scanning element 200. In this embodiment, the switchable scattering panel 140 is, for example, a polymer dispersed liquid crystal (PDLC) panel, and comprises an electrode 142, an electrode 146, and a PDLC layer 144 between the electrode 142 and the electrode 146. The switchable scattering panel 140 is adapted to switch to a blurry condition (for example, the control unit 130 applying voltage between the electrodes 142 and 146 to make the PDLC layer 144 blurry) to scatter the light or a clear condition (for example, the control unit 130 not applying voltage between the electrodes 142 and 146 to make the PDLC layer 144 clear) to pass the light through, so as to switch the stereoscopic display 100i between a 2-dimensional mode and a 3-dimensional mode. That is to say, when the switchable scattering panel 140 is in the blurry condition, the stereoscopic display 100i is switched to the 2-dimensional mode. When the switchable scattering panel 140 is in the clear condition, the stereoscopic display 100i is switched to the 3-dimensional mode.

In another embodiment, the switch between the 2-dimensional mode and the 3-dimensional mode may also be achieved by the stereoscopic display 100 (referring to FIG. 1B). The stereoscopic display 100 does not have switchable scattering panel 140.

However, when the stereoscopic display 100 is switched to 2-dimensional mode, the pixels 112 of the displaying element 110 show the same image when the scanning element 210 scans from the state shown in FIG. 3A to the state shown in FIG. 3B, so that the user can see the same image in view regions A1, A2, and A3, which means the user sees a 2-dimensional image.

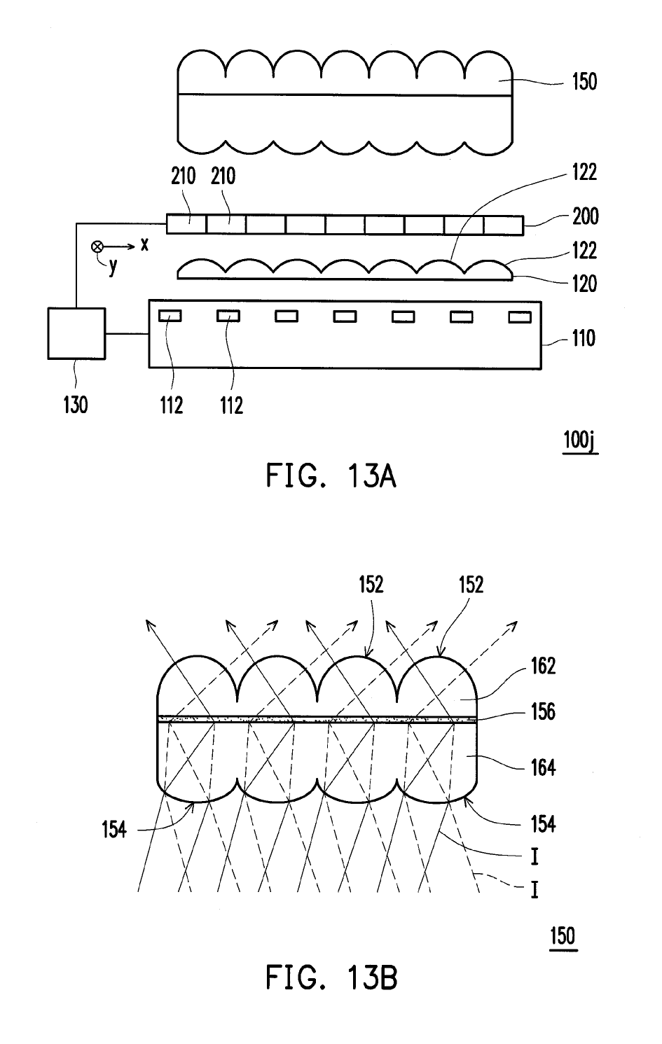

FIG. 13A is a schematic cross-section view of a stereoscopic display according to yet still exemplary embodiment, and FIG. 13B is a schematic cross-section view of the lenticular array assembly in FIG. 13A. Referring to FIGS. 13A and 13B, the stereoscopic display 100j in this embodiment is similar to the stereoscopic display 100 in FIG. 1B, and the difference therebetween is as follows. In this embodiment, the stereoscopic display 100j further comprises a lenticular array assembly 150, wherein the scanning element 200 is disposed between the displaying element 110 and the lenticular array assembly 150. The lenticular array assembly 150 comprises a plurality of first strip-shaped convex surfaces 152 and a plurality of second strip-shaped convex surfaces 154. The first strip-shaped convex surfaces 152 are arranged along a direction (e.g. the x-direction), and each of the first strip-shaped convex surfaces 152 extends along another direction (e.g. the y-direction). The second strip-shaped convex surfaces 154 are arranged along the x-direction, and each of the second strip-shaped convex surfaces 154 extends along the y-direction. The first strip-shaped convex surfaces 152 and the second strip-shaped convex surfaces 154 face away from each other. In this embodiment, the lenticular array assembly 150 further comprises a diffusion film 156 disposed between the first strip-shaped convex surfaces 152 and the second strip-shaped convex surfaces 154. For example, the first strip-shaped convex surfaces 152 are on a lenticular array 162, the second strip-shaped convex surfaces 154 are on another lenticular array 164, and the diffusion film 156 is disposed between the lenticular arrays 162 and 164.

In this embodiment, the diffusion film 156 is substantially disposed on foci f₁ of the first strip-shaped convex surfaces 152 and on foci f₂ of the second strip-shaped convex surfaces. If the scanning angle range of the scanning element 200 is θ, after the light I passes through the lenticular array assembly 150, the scanning angle range of the image I become θ′, wherein θ′=tan⁻¹(f₂·tan θ/f₁). In this embodiment, f₂ is greater than f₁, so that θ′ is greater than θ. When f₂/f₁ is greater, θ′ is greater than θ more. As a result, if the scanning angle range of the scanning element 200 is not very large, the lenticular array assembly 150 effectively increases the scanning angle range of the light I. Besides, the lenticular array assembly 150 transmit the light I to a view region opposite to the view region to which the scanning element 200 transmit. For example, when the scanning element 200 scans from the left to the right, the light I after passing through the lenticular array assembly 150 scans from the right to the left. As a result, the sequence of the frames displayed by the displaying element 110 in this embodiment is reversed with respect to the sequence of the frames displayed by the displaying element 110 of the stereoscopic display 100 in FIG. 1B.

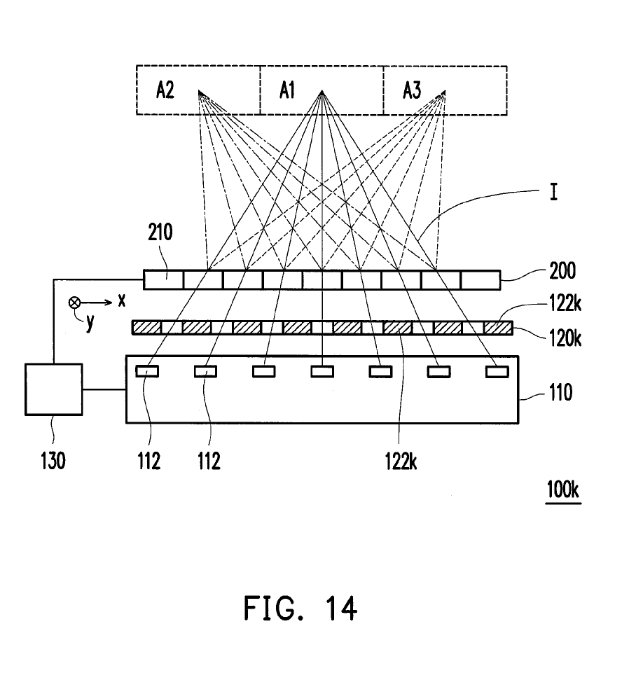

FIG. 14 is a schematic cross-section view of a stereoscopic display according to yet still exemplary embodiment. Referring to FIG. 14, the stereoscopic display 100k in this embodiment is similar to the stereoscopic display 100 in FIG. 1B, and the difference therebetween is as follows. In this embodiment, the converging element 120k is a parallax barrier. The parallax barrier comprises a plurality of discrete opaque strips 122k arranged along a direction (e.g. the x-direction), and each of the opaque strips 122k extends along another direction (e.g. the y-direction). The pitch of the discrete opaque strips 122k corresponds to N times the pitch of pixels 112 of the displaying element 110, and N is a natural number. The light I passes through the region between two opaque strips 122k, and the effect of the parallax barrier is similar to that of the lenticular array.

When N is greater than or equal to 2, every N adjacent lines of the pixels 112 form a pixel set, and the control unit 130 is also for driving different lines of the pixels 112 in each of the pixel sets to respectively show images of N different viewing angles at substantially the same time.

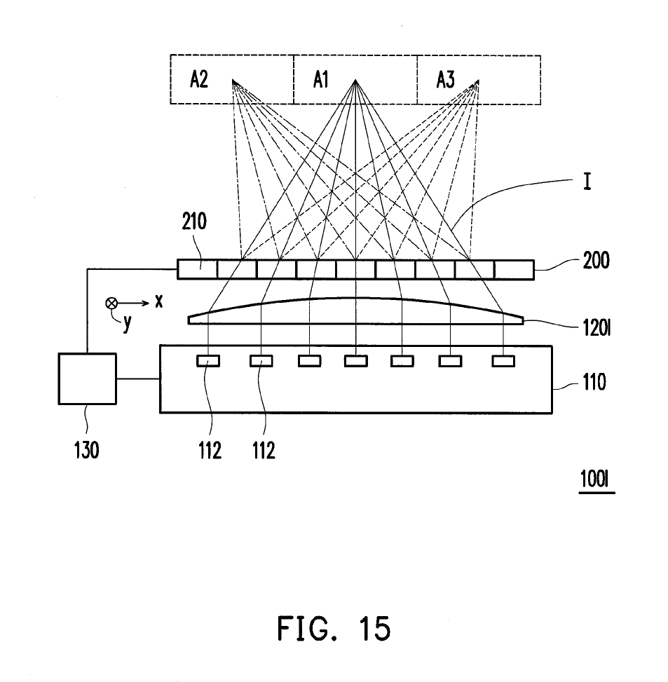

FIG. 15 is a schematic cross-section view of a stereoscopic display according to yet still exemplary embodiment. Referring to FIG. 15, the stereoscopic display 1001 in this embodiment is similar to the stereoscopic display 100 in FIG. 1B, and the difference therebetween is as follows. In the stereoscopic display 1001 according to this embodiment, the light converging element 1201 is a lens, for example, a single plane-convex lenticular lens, and the light I provided by the displaying element 110 is a collimated beam, for example, a parallel beam. The light converging element 1201 converges the light I to the view region A1, and the scanning element 200 makes the light I scan from view region A1 through view region A2 to the view region A3.

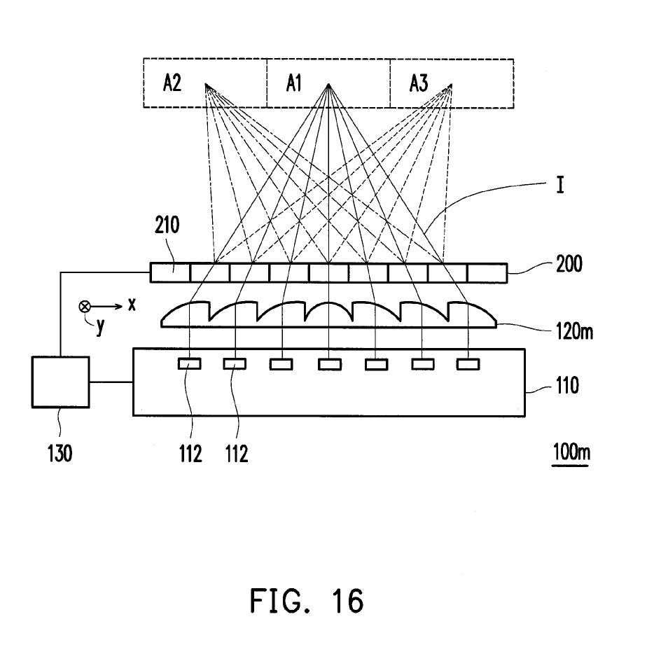

FIG. 16 is a schematic cross-section view of a stereoscopic display according to yet still exemplary embodiment. Referring to FIG. 16, the stereoscopic display 100m in this embodiment is similar to the stereoscopic display 1001 in FIG. 15, and the difference therebetween is as follows. In the stereoscopic display 100m, the light converging element 120m is a Fresnel lens, which has a reduced thickness smaller than the thickness of the light converging element 1201. As a result, the overall thickness of the stereoscopic display 100m can be reduced.

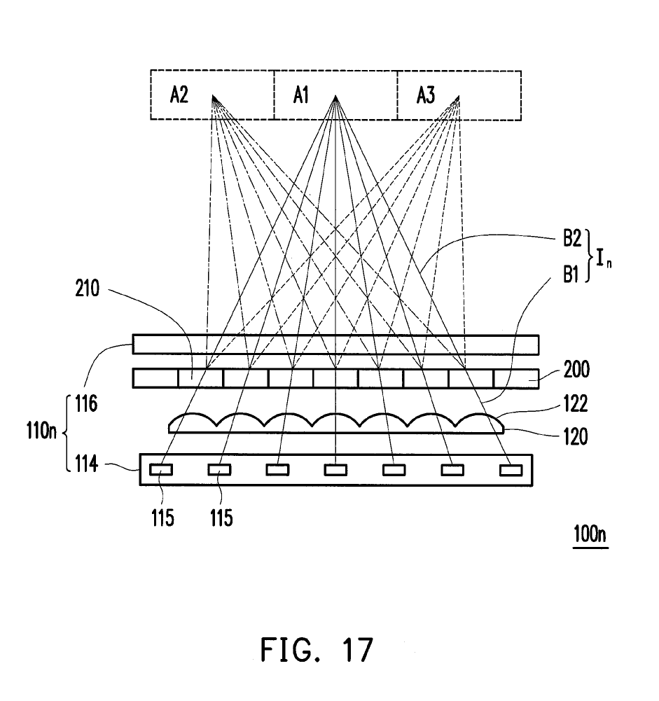

FIG. 17 is a schematic cross-sectional view of the stereoscopic display according to yet still exemplary embodiment. Referring to FIG. 17, the stereoscopic display 100n of this embodiment is similar to the stereoscopic display 100 shown in FIG. 1B, and the difference therebetween is as follows. In the stereoscopic display 100n of this embodiment, the displaying element 110n comprises a backlight module 114 and a display panel 116. In this embodiment, the backlight module 114 comprises a plurality of linear light sources 115. The linear light sources 115 may be substantially parallel to the rod-shaped lenticular lenses 122. Each of the linear light source 115 is, for example, a cold cathode fluorescent lamp (CCFL), a line of light emitting diodes (LEDs), or another light emitting element. Moreover, in this embodiment, the display panel 116 is, for example, a liquid crystal display panel.

The light Iₙ comprises an illumination light B1 and an image light B2. The backlight module 114 is adapted to emit the illumination light B1. The display panel 116 is disposed on a transmission path of the illumination light B1 for converting the illumination light B1 into the image light B2, and the light converging element 120 is disposed on the transmission path of the illumination light B1 between the backlight module 114 and the display panel 116. In this embodiment, the scanning element 200 is disposed on the transmission path of the illumination light B1 between the display panel 116 and the light converging element 120. However, in other embodiments, the scanning element 200 may also be disposed on a transmission of the image light B2 between the display panel 116 and the user.

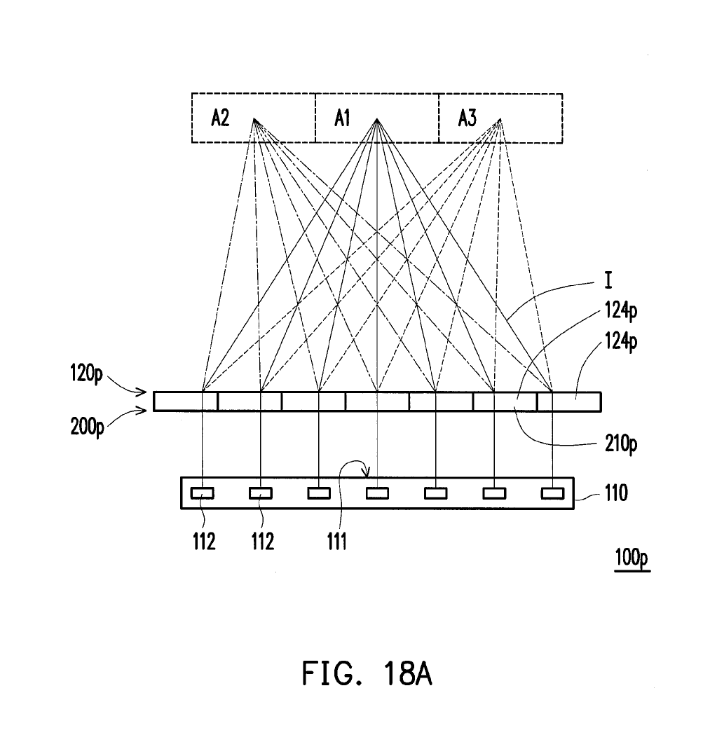

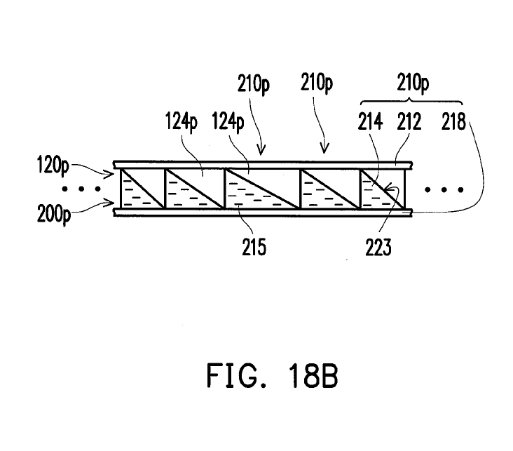

FIG. 18A is a schematic cross-sectional view of the stereoscopic display according to still yet another exemplary embodiment, and FIG. 18B is a schematic cross-sectional view of the scanning element in FIG. 18A. Referring to FIG. 18A and

FIG. 18B, the stereoscopic display 100p of this embodiment is similar to the stereoscopic display 100 in FIG. 1B, and the difference therebetween is as follows. In the stereoscopic display 100p of this embodiment, a light converging element 120p comprises a plurality of transparent materials 124p respectively disposed on the first material 214 with anisotropic refractive indices, and the interfaces 223 respectively between the first material 214 with anisotropic refractive indices and the transparent materials 214 have different slopes with respect to a displaying surface 111 of the displaying element 110. In this embodiment, the slopes of the interfaces 223 increase from the center of the light converging element 120p to the edges of the light converging element 120p, so that the light converging element 120p may also converge the light I. In this embodiment, each of the transparent materials 124p is disposed between the first electrode 212 and the second electrode 218. In other words, the converging element 120p of this embodiment is combined into the scanning element 200p, and the transparent materials 124p of the light converging element 120p are respectively combined into the scanning units 120p of the scanning element 200p. Each of the transparent materials 124p is, for example, a solid prism, a liquid, or a material with anisotropic refractive indices, and this material with anisotropic refractive indices is, for example, liquid crystal.

In view of the above, the stereoscopic display according to the exemplary embodiments has the scanning element using the material with anisotropic refractive indices to make the light scan a plurality of view regions, so that the multi-view images are achieved. Moreover, the operation frequency of the scanning element according to the exemplary embodiments can be lower, so that the stereoscopic display 100 of this embodiment is favorable for mass production, and it has more applicability.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A stereoscopic display comprising:
a displaying element adapted to provide a light;
a light converging element disposed on a transmission path of the light for converging the light to at least one view region; and
a scanning element disposed on the transmission path of the light for changing at least one transmission direction of the light with time, wherein the scanning element comprises a plurality of scanning units, and each of the scanning units comprises:
a first electrode;
a second electrode; and
a first material with anisotropic refractive indices disposed between the first electrode and the second electrode, wherein when voltage between the first electrode and the second electrode is changed, the molecules of the first material with anisotropic refractive indices rotate so as to change the transmission direction of the light with time.

2. The stereoscopic display according to claim 1, wherein the converging element is a lenticular array.

3. The stereoscopic display according to claim 2, wherein the lenticular array comprises a plurality of rod-shaped lenticular lenses arranged along a direction, a pitch of the rod-shaped lenticular lenses corresponds to N time(s) a pitch of pixels of the displaying element, and N is a natural number.

4. The stereoscopic display according to claim 3 further comprising a control unit for controlling the voltage between the first electrode and the second electrode so as to control rotation of the molecules of the first material with anisotropic refractive indices, wherein N is greater than or equal to 2, every N adjacent lines of the pixels form a pixel set, the control unit is also for driving different lines of the pixels in each of the pixel sets to respectively show images of N different viewing angles at substantially the same time.

5. The stereoscopic display according to claim 1, wherein the converging element is a parallax barrier.

6. The stereoscopic display according to claim 5, wherein the parallax barrier comprises a plurality of discrete opaque strips arranged along a direction, a pitch of the discrete opaque strips corresponds to N time(s) a pitch of pixels of the displaying element, and N is a natural number.

7. The stereoscopic display according to claim 6 further comprising a control unit for controlling the voltage between the first electrode and the second electrode so as to control rotation of the molecules of the first material with anisotropic refractive indices, wherein N is greater than or equal to 2, every N adjacent lines of the pixels form a pixel set, the control unit is also for driving different lines of the pixels in each of the pixel sets to respectively show images of N different viewing angles at substantially the same time.

8. The stereoscopic display according to claim 1, wherein the light converging element is a lens, and the light provided by the displaying element is a collimated beam.

9. The stereoscopic display according to claim 1 further comprising a control unit for controlling the voltage between the first electrode and the second electrode so as to control rotation of the molecules of the first material with anisotropic refractive indices.

10. The stereoscopic display according to claim 9, wherein the control unit controls the displaying element to display a plurality of frames at different time respectively corresponding to transmission orientations of the light at different time.

11. The stereoscopic display according to claim 9, wherein the first electrode comprises a plurality of discrete sub-electrodes arranged from a first end of the first electrode to a second end of the first electrode, the control unit is adapted to respectively apply a plurality of voltage values to the discrete sub-electrodes, and the voltage values increases or decreases from the first end to the second end.

12. The stereoscopic display according to claim 9 further comprising a sensor for detecting positions of eyes of a user, the control unit controls the rotation of the molecules of the first material with anisotropic refractive indices so that the light scans the positions of the eyes of the user.

13. The stereoscopic display according to claim 12, wherein when the positions of the eyes of the user move, the control unit controls the rotation of the molecules so that the light dynamically follows movement of the eyes of the user.

14. The stereoscopic display according to claim 1, wherein when the control unit changes the voltage between the first electrode and the second electrode from a first voltage value to a second voltage value, the light scans from a first orientation to a second orientation, and when the control unit changes the voltage between the first electrode and the second electrode from the second voltage value to the first voltage value, the light scans from the second orientation to the first orientation.

15. The stereoscopic display according to claim 14, wherein the first voltage value is substantially zero.

16. The stereoscopic display according to claim 1, wherein the light provided by the displaying element is a linearly polarized beam.

17. The stereoscopic display according to claim 1, wherein each of the scanning units further comprises a transparent material disposed beside the first material with anisotropic refractive indices and between the first electrode and the second electrode, and an interface of the first material with anisotropic refractive indices and the transparent material is inclined with respect to a displaying surface of the displaying element.

18. The stereoscopic display according to claim 17, wherein the transparent material is a solid prism.

19. The stereoscopic display according to claim 17, wherein each of the scanning unit further comprises a transparent plate disposed at the interface, the transparent material is liquid, and the transparent plate separates the first material with anisotropic refractive indices and the transparent material.

20. The stereoscopic display according to claim 17, wherein the transparent material is a second material with anisotropic refractive indices.

21. The stereoscopic display according to claim 20, wherein each of the scanning unit further comprises a transparent plate disposed at the interface.

22. The stereoscopic display according to claim 21, wherein the transparent plate is a third electrode.

23. The stereoscopic display according to claim 1, wherein the light converging element is disposed between the displaying element and the scanning element.

24. The stereoscopic display according to claim 1, wherein the scanning element is disposed between the displaying element and the light converging element.

25. The stereoscopic display according to claim 1 further comprising a switchable scattering panel disposed on the transmission path of the light between the light converging element and the scanning element, wherein the switchable scattering panel is adapted to switch to a blurry condition to scatter the light or a clear condition to pass the light through, so as to switch the stereoscopic display between a 2-dimensional mode and a 3-dimensional mode.

26. The stereoscopic display according to claim 1 further comprising a lenticular array assembly, wherein the scanning element is disposed between the displaying element and the lenticular array assembly, and the lenticular array assembly comprises:
a plurality of first strip-shaped convex surfaces arranged along a direction; and
a plurality of second strip-shaped convex surfaces arranged along the direction, wherein the first strip-shaped convex surfaces and the second strip-shaped convex surfaces face away from each other.

27. The stereoscopic display according to claim 26, wherein the lenticular array assembly further comprises a diffusion film disposed between the first strip-shaped convex surfaces and the second strip-shaped convex surfaces.

28. The stereoscopic display according to claim 27, wherein the diffusion film is substantially disposed on foci of the first strip-shaped convex surfaces and on foci of the second strip-shaped convex surfaces.

29. The stereoscopic display according to claim 1, wherein the light is a image light.

30. The stereoscopic display according to claim 1, wherein the displaying element comprises:
a backlight module, wherein the light comprises an illumination light and an image light, and the backlight module is adapted to emit the illumination light; and
a display panel disposed on a transmission path of the illumination light for converting the illumination light into the image light, wherein the light converging element is disposed on the transmission path of the illumination light between the backlight module and the display panel.

31. The stereoscopic display according to claim 1, wherein the displaying element is a self-luminous display.

32. The stereoscopic display according to claim 1, wherein the light converging element comprises a plurality of transparent materials respectively disposed on the first material with anisotropic refractive indices, interfaces respectively between the first material with anisotropic refractive indices and the transparent materials have different slopes with respect to a displaying surface of the displaying element.

33. The stereoscopic display according to claim 32, wherein each of the transparent materials is disposed between the first electrode and the second electrode.

34. The stereoscopic display according to claim 32, wherein each of the transparent materials is a prism, a liquid, or a second material with anisotropic refractive indices.
